(19) United States
(12) Patent Application Publication
(10) Pub. No.: US 2017/0019310 A1
(43) Pub. Date: Jan. 19, 2017

(54) METHOD AND SYSTEM FOR EFFECTIVE BANDWIDTH ESTIMATION

(71) Applicant: WATERFORD INSTITUTE OF TECHNOLOGY, Waterford (IE)

(72) Inventor: Alan Davy, Waterford (IE)

(73) Assignee: WATERFORD INSTITUTE OF TECHNOLOGY, Waterford (IE)

(21) Appl. No.: 15/203,662

(22) Filed: Jul. 6, 2016

Related U.S. Application Data
(60) Provisional application No. 62/192,189, filed on Jul. 14, 2015.

(51) Int. Cl. H04L 12/24; H04L 12/851; H04L 12/26

(52) U.S. Cl. CPC H04L 41/145; H04L 43/10; H04L 47/2483; H04L 43/0894; H04L 43/0858

(57) ABSTRACT

A method for modelling a relationship between effective bandwidth coefficient (EBC) and mean throughput in a network includes: calculating an EBC for each sample packet trace of a specified traffic type, where the EBC is the ratio of the estimated effective bandwidth EB to mean traffic flow rate M of the sample packet trace; storing the EBC for each sample packet trace with the associated value of M; and modelling EBC versus M for a plurality of values of M for the specified traffic type. Calculating the EBC includes: setting a maximum packet delay target parameter and a violation target parameter for a specified traffic type; collecting a sample packet trace of the specified traffic type from a selected measurement point on the network; estimating the EB of the sample packet trace using the maximum packet delay target parameter and a violation target parameter; and calculating the EBC for the sample packet trace as EBC=EB/M.

### CROSS-REFERENCE TO RELATED APPLICATION

This application claims the benefit, under 35 U.S.C. §119(e), of U.S. Provisional Application No. 62/192,198, filed Jul. 14, 2015, the disclosure of which is incorporated herein by reference in its entirety.

### FEDERALLY-SPONSORED RESEARCH OR DEVELOPMENT

Not applicable.

### BACKGROUND

The present disclosure relates to a method and system for modelling a relationship between effective bandwidth coefficient and mean throughput in a data communication network, which allows estimation of the effective bandwidth of traffic flows.

The effective bandwidth of a packet-based traffic flow relates to the minimum amount of bandwidth required by a link to ensure that specified Quality of Service (QoS) targets of the traffic flow are maintained as the traffic traverses the link, as discussed in F. P. Kelly, “Notes on Effective Bandwidths,” in Stochastic Networks: Theory and Applications (Editors F. P. Kelly, S. Zachary and I. B. Ziedins), Royal Statistical Society Lecture Notes Series, 4, Oxford University Press, 1996. 141-168.

It is desirable to provide a method and system for modelling a relationship between effective bandwidth coefficient and mean throughput in a data communication network which allows the effective bandwidth of traffic flows to be efficiently estimated online in near real time, without requiring continual packet-level inspection of the target traffic flow, in order to maximize throughput while meeting critical delay sensitive targets.

United States Patent Application Publication No. US 2005/0100009 relates to a method and system for bandwidth estimation. However, the method and system described in this document does not capture the relationship between the mean rate of a traffic flow and its associated effective bandwidth using a linear model. It therefore fails to capture a fundamental property of effective band width, that is, the impact of statistical multiplexing. For the same traffic flow, two different mean rates may have a different mean rate-to-effective bandwidth ratio. The present disclosure addresses this issue.

### SUMMARY

According to an aspect of the present disclosure, there is provided a method for modelling a relationship between effective bandwidth coefficient and mean throughput in a data communication network, the method comprising:
(a) calculating an effective bandwidth coefficient for each of a plurality of sample packet traces of a specified traffic type, where the effective bandwidth coefficient is the ratio of the estimated effective bandwidth to mean traffic flow rate of the sample packet trace;
(b) storing the effective bandwidth coefficient for each sample packet trace in a database, along with the associated mean traffic flow rate; and
(c) building a model of effective bandwidth coefficient versus mean traffic flow rate for a plurality of values of mean rate for the specified traffic type.

By building a model of effective bandwidth coefficient versus mean traffic flow rate for a plurality of values of mean rate for the specified traffic type, the present disclosure reduces the overhead usually associated with online effective bandwidth estimation, thus reducing the cost and energy required to provide effective bandwidth measurement of traffic flows.

The step of building a model of effective bandwidth coefficient versus mean rate for a plurality of values of mean rate for the specified traffic type may comprise:
(c)(i) calculating a linear regression of the logₙ of the effective bandwidth coefficient versus the logₙ of the mean traffic flow rate for each sample packet trace;
(c)(ii) from the linear regression, determining a first model parameter equal to the slope of the line and a second model parameter equal to the y-axis intercept at a plurality of values of mean traffic flow rate; and
(c)(iii) storing the first and second model parameters in the database.

The first and second parameters may be stored for the traffic type, so that they are indexed by the traffic type, which may be represented by a tuple of properties such as source address, destination address, source port, destination port, Type of Service, etc.

The method may further comprise specifying further target traffic types and repeating the steps to build a model of effective bandwidth coefficient versus mean traffic flow rate for a plurality of values of mean traffic flow rate for each further traffic type.

The method may further comprise:
(d) collecting flow level records of a traffic flow matching a specified traffic type; and
(e) calculating the mean traffic flow rate for a period of time for the specified traffic type from the flow records.

The method may further comprise:
(f) estimating the value of the effective bandwidth coefficient corresponding to the calculated mean traffic flow rate based on the model; and
(g) calculating the effective bandwidth of the traffic flow based on the efficient bandwidth coefficient and the mean traffic flow rate.

Estimating the value of the effective bandwidth coefficient may comprise:
(f)(i) retrieving first and second model parameters associated with the calculated mean traffic flow rate for the corresponding traffic type from the database; and
(f)(ii) estimating the effective bandwidth coefficient, EBC, according to the equation EBC=e_{a*ln(M)+b}, where a is the first model parameter, and b is the second model parameter.

Calculating the effective bandwidth of the traffic flow may comprise calculating the effective bandwidth, EB, based on the EBC and the mean traffic flow rate M, according to the equation EB=M*EBC.

According to another aspect of the present disclosure, there is provided a method for calculating an effective bandwidth coefficient in a data communication network, the method comprising:
(a) specifying a target traffic type;
(b) setting a maximum packet delay target parameter and a violation target parameter for the specified traffic type;
(c) collecting a sample packet trace of the specified traffic type from a selected measurement point on the network;
(d) estimating the effective bandwidth of the sample packet trace using the maximum packet delay target parameter and a violation target parameter; and
(e) calculating an effective bandwidth coefficient, EBC, for the sample packet trace according to the equation EBC=EB/M, where EB is the estimated effective bandwidth and M is the mean rate of the traffic flow.

Estimating the effective bandwidth of the sample packet trace may comprise:
(d)(i) processing the sample packet trace through a first-in-first-out, FIFO, queue with infinite buffer at queue service rate R;
(d)(ii) calculating a volume of traffic delayed greater than the maximum packet delay target parameter; and
(d)(iii) if the calculated volume of traffic equals the violation target parameter, returning the queue service rate R as the effective bandwidth measurement of the sample packet trace.

The method may further comprise increasing the queue service rate R and repeating the processing and calculating steps using the new queue service rate, if the calculated volume of traffic is greater than the violation target parameter. The queue service rate R may be increased in line with the following equation:

R=R+(R_{high}−R)/2, where R_{high} is the maximum rate of the traffic flow.

The method may further comprise decreasing the queue service rate R and repeating the processing and calculating steps using the new queue service rate, if the calculated volume of traffic is less than the violation target parameter. The queue service rate R may be decreased in line with the following equation:

R=R−(R−R_{low})/2, where R_{low} is the minimum rate of the traffic flow.

### BRIEF DESCRIPTION OF THE DRAWINGS

FIG. 1 shows a network environment comprising a plurality of mobile and static data communication devices remote from one another and connected to one for data communication, including an effective bandwidth estimation server;

FIG. 2 is a flowchart illustrating a method for estimating an effective bandwidth of a traffic flow in a data communication network, according to an embodiment of the disclosure; and

FIG. 3 is a sample plot of the logₑ of effective bandwidth coefficient versus the logₙ of mean rate.

### DETAILED DESCRIPTION

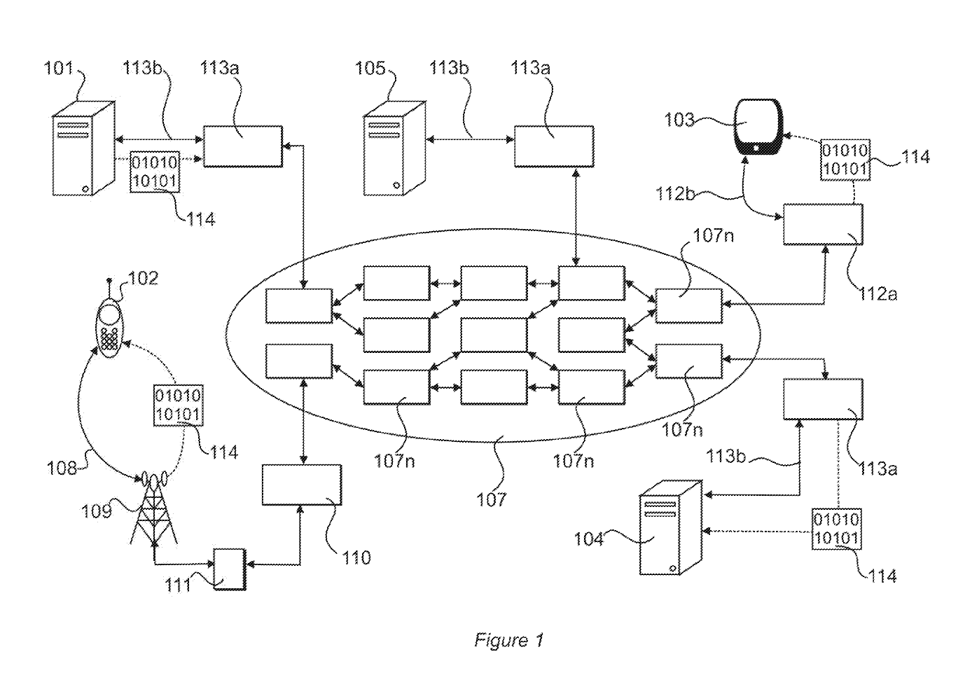

With reference to FIG. 1, an example embodiment of a system according to the disclosure is shown within a networked environment.

The networked environment includes a source node 101 configured to store and broadcast audio video data to a plurality of target nodes 102, 103, 104 on demand, and an effective bandwidth estimation server 105. The audio video data may comprise movies, broadcast programs, music tracks etc. Audio video streaming on demand is described herein as a non-limiting example of a delay-sensitive data distributing application.

The audio video data is broadcast as a digital stream of data packets 106 over a Wide Area Network (WAN) 107, which in this embodiment is the Internet. Any number of data processing devices with wired and/or wireless Wide Area Network connectivity, such as the mobile data communication devices 102, 103 and the personal computer 104 of FIG. 1, may thus receive the audio video data and play it back to a user.

Each mobile data communication device, for instance a mobile telephone handset 102, may have wireless telecommunication emitting and receiving functionality over a cellular telephone network configured according to the Global System for Mobile Communication (GSM), General Packet Radio Service (GPRS), International Mobile Telecommunications-2000 (IMT-2000, W-CDMA or 3G) network industry standards, and wherein telecommunication is performed as voice, alphanumeric or audio-video data using the Short Message Service (SMS) protocol, the Wireless Application protocol (WAP) the Hypertext Transfer Protocol (HTTP) or the Secure Hypertext Transfer Protocol (HTTPS).

Each mobile communication device 102, 103 receives or emits voice, text, audio and/or image data encoded as a digital signal over a wireless data transmission 108, wherein the signal is relayed respectively to or from the device by the geographically-closest communication link relay 109 of a plurality thereof. The plurality of communication link relays 109 allows digital signals to be routed between each device 102, 103 and their destination by means of a remote gateway 110 via a MSC or base station 111. Gateway 110 is, for instance, a communication network switch, which couples digital signal traffic between wireless telecommunication networks, such as the cellular network within which wireless data transmissions 108 take place, and the Wide Area Network 107. The gateway 110 further provides protocol conversion, if required, for instance whether a device 102 uses the WAP or HTTPS protocol to communicate data.

Alternatively, or additionally, each mobile data communication device, for instance a portable tablet computer 103, may have wired and/or wireless telecommunication emitting and receiving functionality over, respectively, a wired Local Area Network (LAN) and/or a wireless local area network (WLAN) conforming to the 802.11 standard (Wi-Fi). In the LAN or WLAN, telecommunication is likewise performed as voice, alphanumeric and/or audio-video data using the Internet Protocol (IP), Voice data over IP (VoIP) protocol, Hypertext Transfer Protocol (HTTP) or Secure Hypertext Transfer Protocol (HTTPS), the signal being relayed respectively to or from the mobile data communication device 103 by a wired (LAN) or wireless (WLAN) router 112a interfacing the mobile data communication device 103 to the WAN communication network 107 via a local wireless connection 112b. Either or both the mobile telephone handset 102 and the portable tablet computer 103 may have wireless telecommunication emitting and receiving functionality over the WLAN in addition to GSM, GPRS, W-CDMA and/or 3G.

A typical mobile data communication device 102, 103 suitable for use with the system according to the disclosure is preferably a smartphone 102. Generally, the mobile data communication device 102, 103 may be any portable data processing device having at least wireless communication means capable of receiving a data communication from, and broadcasting same to, another node in the networked environment. One or more of the mobile data communication devices 102, 103 may instead be a portable computer such as a laptop or netbook, a tablet computer, a personal digital assistant, a portable media player, or even a portable game console.

Each data processing terminal 101, 104, 105 emits and receives data encoded as a digital signal over a wired data transmission conforming to the IEEE 802.3 (Gigabit Ethernet) standard, wherein the signal is relayed respectively to or from the computing device by a respective wired router 113a interfacing the computing device 101, 104, 105 to the WAN communication network 107 via a local wired connection 113b. Generally, each data processing terminal 101, 104, 105 may be any portable or desktop data processing device having at least networking means apt to receive a data communication from, and broadcast same to, another node in the networked environment.

In the communication network of FIG. 1, the effective bandwidth estimation server 105 configures a measurement point at an edge of the network and collects packet analysis results (i.e. effective bandwidth coefficient values) and flow records.

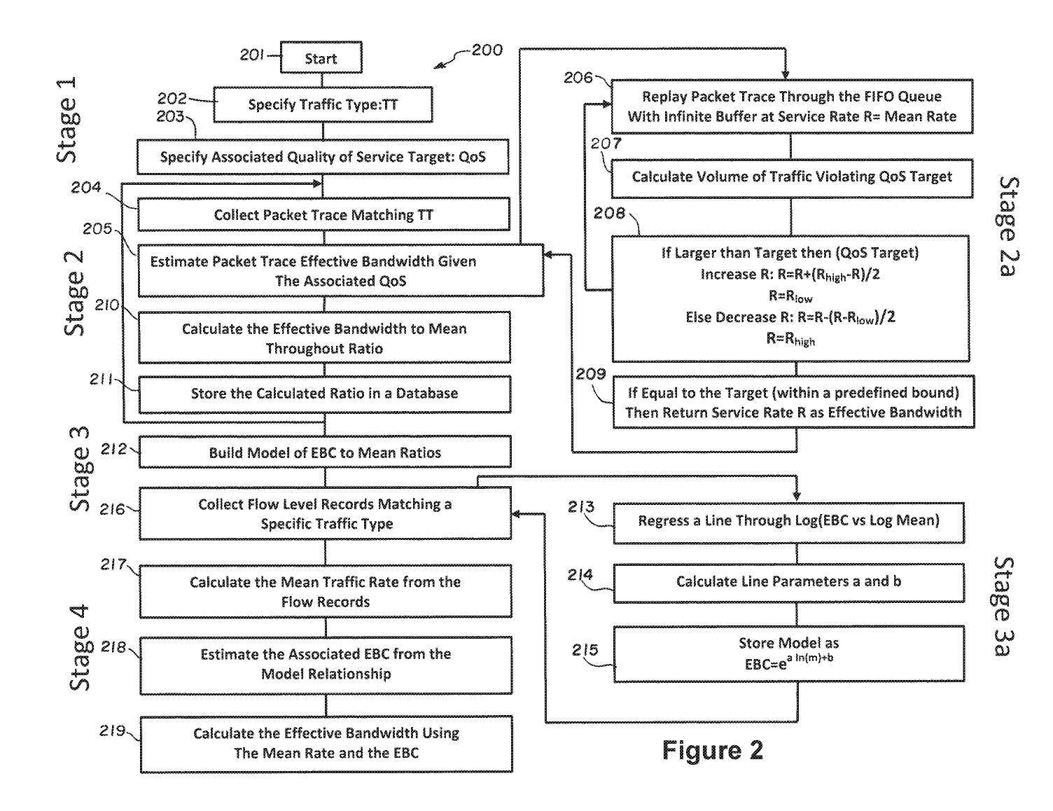

Referring to FIG. 2, there is illustrated a method 200 for estimating an effective bandwidth of a traffic flow in the data communication network of FIG. 1.

The method starts at step 201. At step 202, a target traffic type TT is specified. The network shown in FIG. 1 may be surveyed to determine which traffic types are of interest. The target traffic type may be specified in a number of ways. A common approach is to specify a five-tuple of packet information that can be associated to a traffic flow, such as source IP address, destination IP address, source port, destination port, and a Type of Service (ToS) field. Alternatively, a subset of these fields, such as the ToS field alone, may be used to identify the traffic type.

At step 203, QoS targets for the specified traffic type, including a maximum packet delay target parameter and a violation target parameter, are set. In an example, the maximum packet delay parameter may be 150 ms, with a violation target parameter of 0.001 (or 1 in 1000 packets).

At step 204, a sample packet trace of the specified traffic type is collected from a selected measurement point on the network. The measurement point may be, for example, an interface of a switch 110 in the network. A copy of the packet headers of the packets passing through the interface is taken at the measurement point, and filtered based on the specified traffic type, to obtain a packet trace. The packet header comprises details that can be used to identify the packet such as source address, destination address, source port, destination port, ToS field, and packet size. The packet trace comprises a list of packets contained therein and a timestamp indicating the time at which the sample was obtained.

At step 205, the effective bandwidth for the packet trace at the target QoS is estimated. At step 206, the sample packet trace is replayed or processed through a first-in-first-out, FIFO, queue with infinite buffer at queue service rate R. The service rate R is initially set to be equal to the mean traffic flow rate M of the packet trace, that is, the volume of traffic in the packet trace divided by the time period over which the packet trace was collected. Processing the packet trace through the FIFO emulates the passage of the packet trace through the network and allows a determination to be made as to the size of buffer required to service the packet trace at service rate R.

At step 207, a volume of traffic delayed greater than the maximum packet delay target parameter is calculated.

At step 208, if the calculated volume of traffic is greater than the violation target parameter, the queue service rate R is increased, and the processing 206 and calculating 207 steps are repeated using the new queue service rate. A binary search algorithm is used to select the new rate. The queue service rate R is increased in line with the following equations:

R_{low}=R; and (1)

R=R+(R_{high}−R)/2, where R_{low} is initially set to the minimum traffic flow rate of the packet trace and R_{high} is initially set to the maximum traffic flow rate of the packet trace. (2)

The maximum traffic flow rate for the packet trace is calculated by determining the highest volume of traffic over a rolling 1 second period during sampling of the packet trace. The minimum traffic flow rate for the packet trace is the mean throughput rate of the packet trace, since the effective bandwidth of a traffic flow will never be lower than the mean rate.

If the calculated volume of traffic is less than the violation target parameter, the queue service rate R is decreased and the processing 206 and calculating 207 steps are repeated using the new queue service rate. As above, a binary search algorithm is used to select the new rate. The queue service rate R is decreased in line with the following equations:

R_{high}=R; and (3)

R=R−(R−R_{low})/2, where R_{low} is initially set to the minimum traffic flow rate of the packet trace, and R_{high} is initially set to the maximum traffic flow rate of the packet trace. (4)

At step 209, when the calculated volume of traffic equals the violation target parameter, the queue service rate R is returned as the effective bandwidth measurement EB for the sample packet trace.

In step 210, an effective bandwidth coefficient EBC for the sample packet trace is calculated according to the following equation:

EBC=EB/M. (5)

In step 211, the effective bandwidth coefficient EBC is stored in a database, along with the associated mean rate M.

Steps 204 to 211 are repeated for different sample packet traces for the specified traffic type. A plurality of efficient bandwidth coefficients for different values of M are thereby obtained. In step 212, a model of effective bandwidth coefficient versus mean rate is built for a plurality of values of mean rate for the traffic type. In the example shown in FIG. 1, this involves calculating a linear regression of the logₙ of the EBC versus the logₙ of the mean rate M for the sample packet traces at step 213. From the linear regression, two model parameters are calculated at step 214: parameter a is the slope of the line, and parameter b is the y-axis intercept. At step 215, these parameters are stored in the database, so that for a given traffic type, the effective bandwidth coefficient for any mean rate may be calculated according to the following equation:

EBC=e^{a*ln(M)+b}. (6)

Further target traffic types may be specified, and the steps to build a model of effective bandwidth coefficient versus mean rate for a plurality of values of mean rate repeated for each further traffic type.

At step 216, for a given traffic type, flow records (such as IPFIX, Netflow, jFlow) are collected from specified points on the network. These points may be the same as the measurement points, or may be different points on the network. At step 217, the mean rate or throughput M of the traffic flow is calculated from the flow records over a given time interval. The associated model parameters a and b are selected from the database for the corresponding traffic type, and the EBC is estimated at step 218 using the above equation (6). At step 219, the effective bandwidth EB is calculated based on the EBC and the mean rate M, where EB=M*EBC.

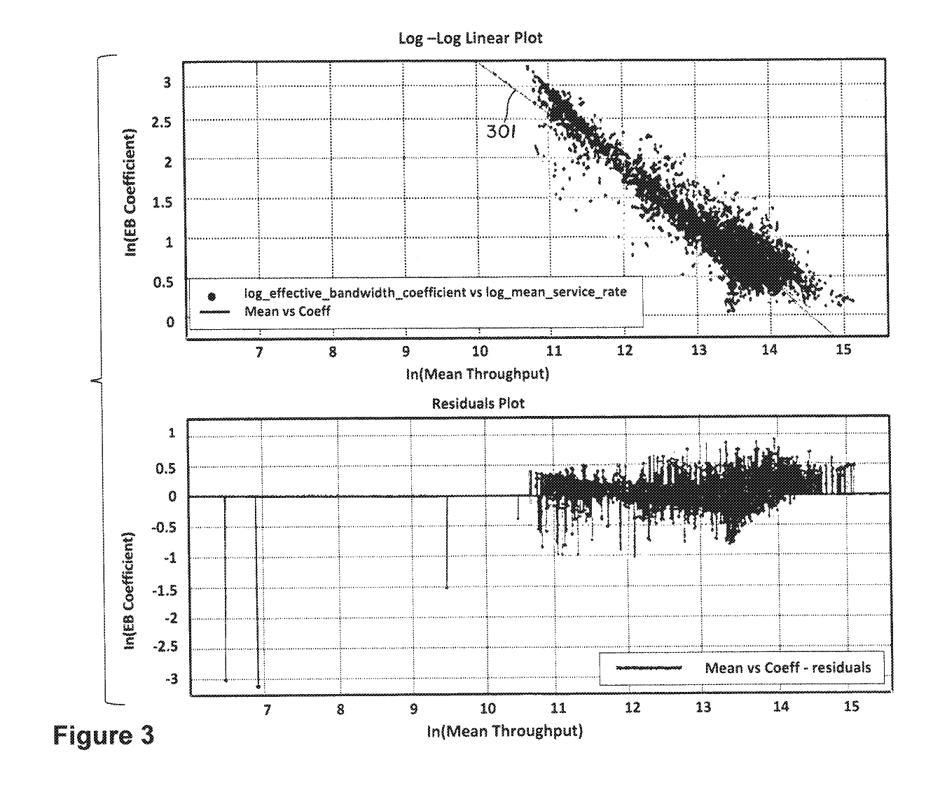

An example of the linear relationship between the logₙ of the effective bandwidth coefficient and the logₙ of the mean rate is shown in FIG. 3, as calculated from a trial on a network. The line 301 represents the linear fit, with the associated model parameters a=0.7395 and b=10.76. The QoS target in this case was 40 ms maximum packet delay target and 0.01 violation target.

The words “comprises/comprising” and the words “having/including” when used herein with reference to the present disclosure are used to specify the presence of stated features, integers, steps or components but does not preclude the presence or addition of one or more other features, integers, steps, components or groups thereof.

It is appreciated that certain features of the disclosure, which are, for clarity, described in the context of separate embodiments, may also be provided in combination in a single embodiment. Conversely, various features of the disclosure which are, for brevity, described in the context of a single embodiment, may also be provided separately or in any suitable sub-combination.

What is claimed is:

1. A method for modelling a relationship between effective bandwidth coefficient and mean throughput in a data communication network, the method comprising:
(a) calculating an effective bandwidth coefficient for each of a plurality of sample packet traces of a specified traffic type, where the effective bandwidth coefficient is the ratio of the estimated effective bandwidth to mean traffic flow rate of the sample packet trace;
(b) storing the effective bandwidth coefficient for each sample packet trace in a database, along with the associated mean traffic flow rate; and
(c) building a model of effective bandwidth coefficient versus mean traffic flow rate for a plurality of values of mean rate for the specified traffic type.

2. The method of claim 1, wherein the step of building a model of effective bandwidth coefficient versus mean rate for a plurality of values of mean rate for the specified traffic type comprises:
(c)(i) calculating a linear regression of the logₑ of the effective bandwidth coefficient versus the logₙ of the mean traffic flow rate for each sample packet trace;
(c)(ii) from the linear regression, determining a first model parameter equal to the slope of the line and a second model parameter equal to the y-axis intercept at a plurality of values of mean traffic flow rate; and
(c)(iii) storing the first and second model parameters in the database.

3. The method of claim 2, further comprising:
(d) specifying further target traffic types and repeating the steps to build a model of effective bandwidth coefficient versus mean traffic flow rate for a plurality of values of mean traffic flow rate for each further traffic type.

4. The method of claim 2, further comprising:
(d) collecting flow level records of a traffic flow matching a specified traffic type; and
(e) calculating the mean traffic flow rate for a period of time for the specified traffic type from the flow records.

5. The method of claim 4, further comprising:
(f) estimating the value of the effective bandwidth coefficient corresponding to the calculated mean traffic flow rate based on the model; and
(g) calculating the effective bandwidth of the traffic flow based on the efficient bandwidth coefficient and the mean traffic flow rate.

6. The method of claim 5, wherein estimating the value of the effective bandwidth coefficient comprises:
(f)(i) retrieving first and second model parameters associated with the calculated mean traffic flow rate for the corresponding traffic type from the database; and
(f)(ii) estimating the effective bandwidth coefficient, EBC, according to the equation EBC=e^{a*ln(M)+b}, where a is the first model parameter and b is the second model parameter.

7. The method of claim 6, wherein calculating the effective bandwidth of the traffic flow comprises calculating the effective bandwidth, EB, based on the EBC and the mean traffic flow rate M, according to the equation EB=M*EBC.

8. A method for calculating an effective bandwidth coefficient in a data communication network, the method comprising:
(a) specifying a target traffic type;
(b) setting a maximum packet delay target parameter and a violation target parameter for the specified traffic type;
(c) collecting a sample packet trace of the specified traffic type from a selected measurement point on the network;
(d) estimating the effective bandwidth of the sample packet trace using the maximum packet delay target parameter and a violation target parameter; and
(e) calculating an effective bandwidth coefficient, EBC, for the sample packet trace according to the equation EBC=EB/M, where EB is the estimated effective bandwidth and M is the mean rate of the traffic flow.

9. The method of claim 8, wherein estimating the effective bandwidth of the sample packet trace comprises:
(d)(i) processing the sample packet trace through a first-in-first-out, FIFO, queue with infinite buffer at queue service rate R;
(d)(ii) calculating a volume of traffic delayed greater than the maximum packet delay target parameter; and
(d)(iii) if the calculated volume of traffic equals the violation target parameter, returning the queue service rate R as the effective bandwidth measurement of the sample packet trace.

10. The method of claim 9, further comprising:
(d)(iv) if the calculated volume of traffic is greater than the violation target parameter, increasing the queue service rate R and repeating the processing and calculating steps using the new queue service rate.

11. The method of claim 10, wherein the queue service rate R is increased in line with the following equation:
R=R+(R_{high}−R)/2, where R_{high} is the maximum rate of the traffic flow.

12. The method of claim 9, further comprising:
(d)(v) if the calculated volume of traffic is less than the violation target parameter, decreasing the queue service rate R and repeating the processing and calculating steps using the new queue service rate.

13. The method of claim 12, wherein the queue service rate R is decreased in line with the following equation:
R=R−(R−R_{low})/2, where R_{low} is the minimum rate of the traffic flow.

14. A system for modelling a relationship between effective bandwidth coefficient and mean throughput in a data communication network, the system comprising:
logic configured to calculate an effective bandwidth coefficient for each of a plurality of sample packet traces of a specified traffic type, where the effective bandwidth coefficient is the ratio of the estimated effective bandwidth to mean traffic flow rate of the sample packet trace;
logic configured to store the effective bandwidth coefficient for each sample packet trace in a database, along with the associated mean traffic flow rate; and
logic configured to build a model of effective bandwidth coefficient versus mean traffic flow rate for a plurality of values of mean traffic flow rate for the specified traffic type.

15. A system for calculating an effective bandwidth coefficient in a data communication network, the system comprising:
logic configured to specify a target traffic type;
logic configured to set a maximum packet delay target parameter and a violation target parameter for the specified target traffic type;
logic configured to collect a sample packet trace of the specified target traffic type from a selected measurement point on the network;
logic configured to estimate the effective bandwidth of the sample packet trace using the maximum packet delay target parameter and a violation target parameter; and
logic configured to calculate an effective bandwidth coefficient, EBC, for the sample packet trace according to the equation EBC=EB/M, where EB is the estimated effective bandwidth and M is the mean rate of the traffic flow.

16. A computer-readable medium comprising instructions which, when executed by a processor, cause the processor to perform the steps of:
(a) calculating an effective bandwidth coefficient for each of a plurality of sample packet traces of a specified traffic type, where the effective bandwidth coefficient is the ratio of the estimated effective bandwidth to mean traffic flow rate of the sample packet trace;
(b) storing the effective bandwidth coefficient for each sample packet trace in a database, along with the associated mean traffic flow rate; and
(c) building a model of effective bandwidth coefficient versus mean traffic flow rate for a plurality of values of mean rate for the specified traffic type.

17. A computer-readable medium comprising instructions which, when executed by a processor, cause the processor to perform the steps of:
(a) specifying a target traffic type;
(b) setting a maximum packet delay target parameter and a violation target parameter for the specified target traffic type;
(c) collecting a sample packet trace of the specified target traffic type from a selected measurement point on the network;
(d) estimating an effective bandwidth of the sample packet trace using the maximum packet delay target parameter and a violation target parameter; and
(e) calculating an effective bandwidth coefficient, EBC, for the sample packet trace according to the equation EBC=EB/M, where EB is the estimated effective bandwidth and M is the mean rate of the traffic flow.
